(19) United States
(12) Patent Application Publication
(10) Pub. No.: US 2025/0106649 A1
(43) Pub. Date: Mar. 27, 2025

(54) SYSTEMS AND METHODS FOR WI-FI LINK RATE ADAPTATION

(71) Applicant: GM Global Technology Operations LLC, Detroit, MI (US)

(72) Inventors: Azin Neishaboori, Plymouth, MI (US); Lakshmi V. Thanayankizil, Troy, MI (US)

(73) Assignee: GM Global Technology Operations LLC, Detroit, MI (US)

(21) Appl. No.: 18/471,629

(22) Filed: Sep. 21, 2023

(51) Int. Cl. H04W 24/02; G07C 5/00; H04W 76/10; H04W 84/00; H04W 84/12

(52) U.S. Cl. CPC H04W 24/02; G07C 5/008; H04W 76/10; H04W 84/005; H04W 84/12

(57) ABSTRACT

A system for a vehicle comprises a WiFi station, data processing hardware including, and memory hardware in communication with the data processing hardware, the memory hardware storing instructions that when executed on the data processing hardware cause the data processing hardware to perform operations comprising detecting an access point, establishing a link between the access point and the WiFi station, obtaining recent yaw rate data of the vehicle, obtaining recent speed data of the vehicle, obtaining recent acceleration data of the vehicle, obtaining recent mobility pattern data of the vehicle based on geolocation data and map data, and determining optimal physical (PHY) parameters corresponding to highest data rate based on at least one of the recent yaw rate data, the recent speed data, the recent acceleration data, or the recent mobility pattern data.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to systems and methods for Wi-Fi link rate adaptation. Specifically, when a vehicle's embedded telematics unit in Wi-Fi client Station (STA) mode attempts to establish a Wi-Fi connection with an Access Point (AP) in the communication range for internet connectivity, the Modulation-Coding Scheme (MCS) for the link between STA and AP is determined based on the instantaneous link quality. For example, when the vehicle is in full stop at a red light, a very good link may exist between the STA and the AP with high Signal to Interference & Noise Ratio (SINR). Therefore, the AP may select an MCS corresponding to high data rate and code rate. However, shortly thereafter, the vehicle may resume movement and leave the traffic light. Soon thereafter, a significantly worse link quality (e.g., low SINR) may exist. The AP subsequently adapts the MCS based on the perceived Packet Error Rate (PER) experienced by the STA and reflected in the packets not reported as received in Block Acknowledgement (Block Ack) packets. However, such link adaptation takes time and disrupts current sessions leading to poor Quality of Experience (QoE).

Accordingly, there is room for improvement in the QoE for Wi-Fi connection between a vehicle STA and AP.

### SUMMARY

One aspect of the disclosure provides a system for a vehicle comprising a WiFi station, data processing hardware, and memory hardware in communication with the data processing hardware, the memory hardware storing instructions that when executed on the data processing hardware cause the data processing hardware to perform operations comprising detecting an access point, establishing a link between the access point and the WiFi station, obtaining recent yaw rate data of the vehicle, obtaining recent speed data of the vehicle, obtaining recent acceleration data of the vehicle, obtaining recent mobility pattern data of the vehicle based on geolocation data and map data, and determining optimal physical (PHY) parameters corresponding to highest data rate based on at least one of the recent yaw rate data, the recent speed data, the recent acceleration data, or the recent mobility pattern data.

Implementations of the disclosure include one or more of the following optional features. In some implementations, the operations further comprise obtaining packet error rate data. Determining the optimal PHY parameters may be based at least partially on the packet error rate data. Determining the optimal PHY parameters may include changing to different PHY parameters if the packet error rate is below a pre-determined threshold for a pre-determined amount of time.

The operations may further comprise optimizing quality of service criteria for active applications of the system based on the determined optimal PHY parameters.

The recent mobility pattern data may include data obtained from at least a second vehicle separate from the vehicle.

The recent mobility pattern data may include data obtained from at least a second vehicle separate from the vehicle.

Another aspect of the disclosure provides a computer-implemented method when executed on data processing hardware causes the data processing hardware to perform operations comprising detecting an access point, establishing a link between the access point and a WiFi station, obtaining recent yaw rate data of a vehicle, obtaining recent speed data of the vehicle, obtaining recent acceleration data of the vehicle, obtaining recent mobility pattern data of the vehicle based on geolocation data and map data, and determining optimal physical (PHY) parameters corresponding to highest data rate based on at least one of the recent yaw rate data, the recent speed data, the recent acceleration data, or the recent mobility pattern data.

Implementations of the disclosure include one or more of the following optional features. In some implementations, the operations may further comprise obtaining packet error rate data. The operations may further comprise obtaining packet error rate data. Determining the optimal PHY parameters may include changing to different PHY parameters if the packet error rate is below a pre-determined threshold.

The operations may further comprise optimizing quality of service criteria for active applications based on the determined optimal PHY parameters.

The recent mobility pattern data may include data obtained from at least two separate vehicles.

Determining the optimal PHY parameters may include use of artificial intelligence or machine learning.

Another aspect of the disclosure provides a computer-implemented method when executed on data processing hardware causes the data processing hardware to perform operations comprising detecting an access point, establishing a link between the access point and a WiFi station, obtaining optimization data based on recent mobility data of a vehicle, determining optimal physical (PHY) parameters corresponding to highest data rate based on the recent mobility data of the vehicle.

Implementations of the disclosure include one or more of the following optional features. In some implementations, the recent mobility data includes at least one of recent yaw rate data of the vehicle, recent speed data of the vehicle, recent acceleration data of the vehicle, or recent mobility pattern data of the vehicle based on geolocation data and map data.

The operations may further comprise obtaining packet error rate data. Determining the optimal PHY parameters may be based at least partially on the packet error rate data.

Determining the optimal PHY parameters may include changing to different PHY parameters if the packet error rate is below a pre-determined threshold.

The operations may further comprise optimizing quality of service criteria for active applications based on the determined optimal PHY parameters.

The details of one or more implementations of the disclosure are set forth in the accompanying drawings and description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic of a system for Wi-Fi link rate adaptation, in accordance with the present disclosure;

FIG. 2 is an exemplary method for implementing the system for Wi-Fi link rate adaptation of FIG. 1;

FIG. 3 is another exemplary method for implementing the system for Wi-Fi link rate adaptation of FIG. 1; and

FIG. 4 is another exemplary method for implementing the system for Wi-Fi link rate adaptation of FIG. 1.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

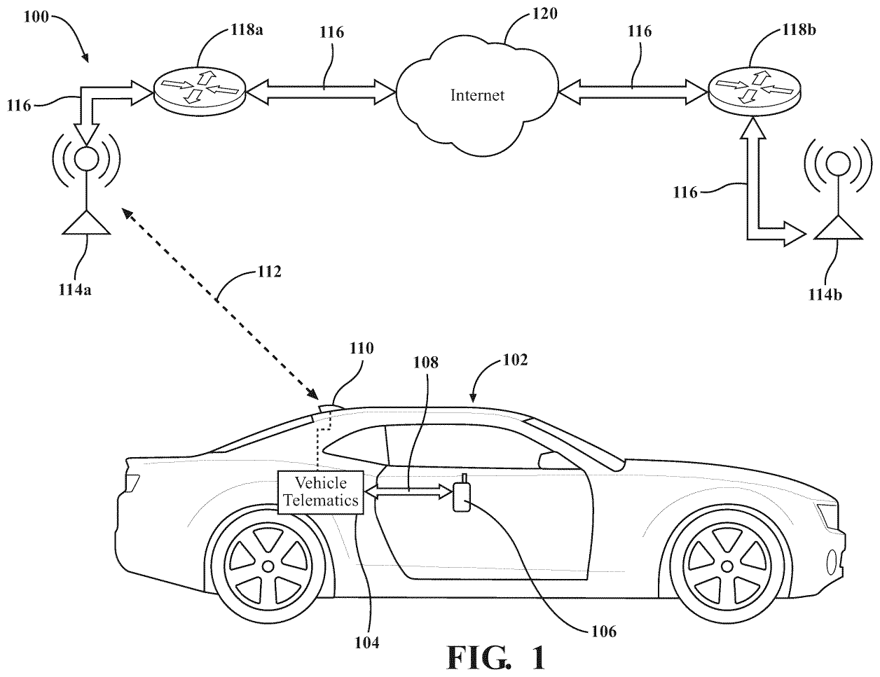

Referring to FIG. 1, a Wi-Fi system 100 is generally shown. The Wi-Fi system 100 includes a vehicle 102, which may be an automobile. As will be appreciated, the vehicle may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain configurations. The vehicle may also comprise a truck, a watercraft, an aircraft, and/or one or more other types of vehicles. In addition, it will also be appreciated that the vehicle may comprise any number of other types of mobile platforms with a system such as the Wi-Fi system 100.

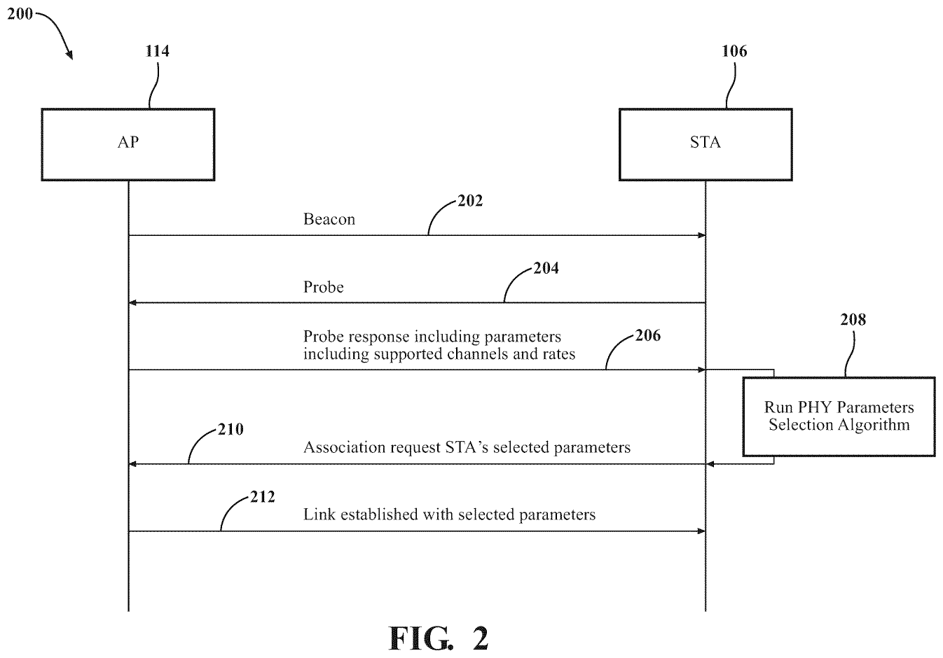

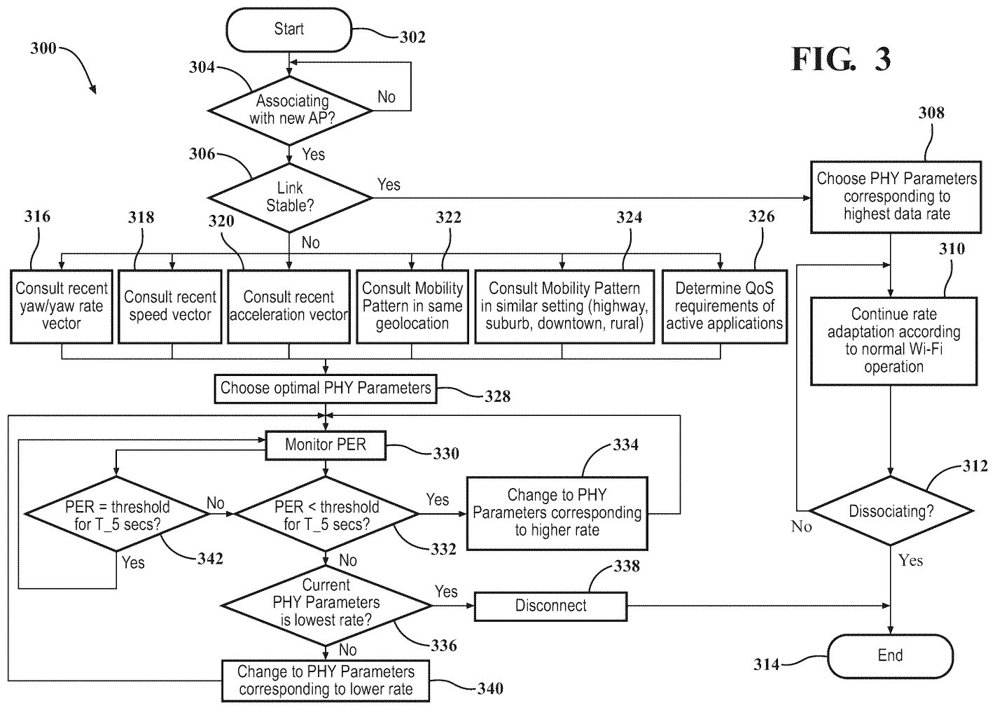

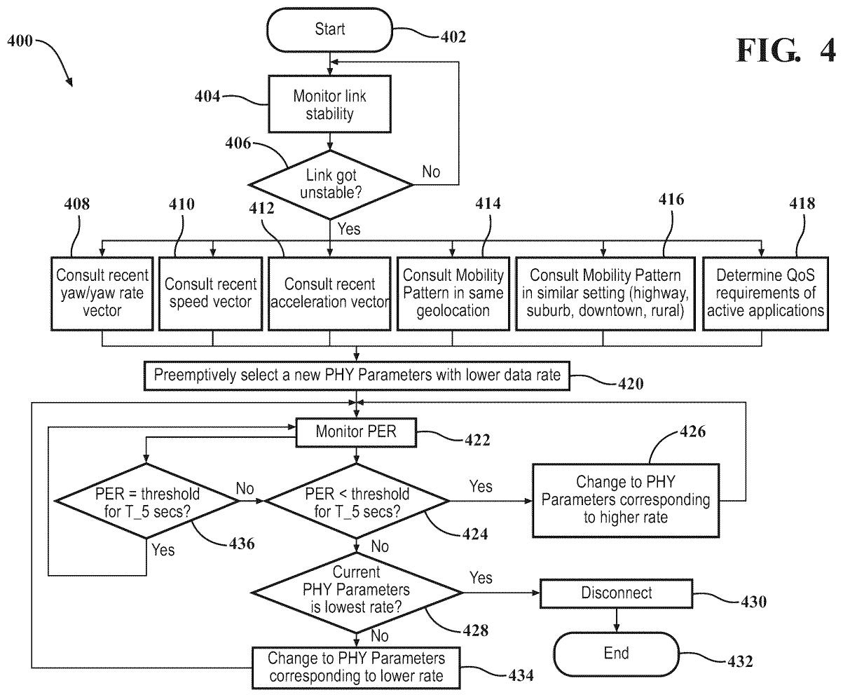

The Wi-Fi system 100 includes a controller comprising a computer system 104, which may also be referred to as a telematics system. The computer system 104 of the controller includes a processor and a memory. The processor performs the computation and control functions of the controller and may comprise any type of processor or multiple processors, single integrated circuits such as a microprocessor, or any suitable number of integrated circuit devices and/or circuit boards working in cooperation to accomplish the functions of a processing unit. During operation, the processor executes one or more programs contained within the memory and, as such, controls the general operation of the controller and the computer system of the controller, generally in executing the processes described herein, such as the method 200 discussed further below in connection with FIG. 2, the method 300 discussed further below in connection with FIG. 3, and the method 400 discussed further below in connection with FIG. 4.

The memory may be any type of suitable memory. For example, the memory may include various types of dynamic random access memory (DRAM) such as SDRAM, the various types of static RAM (SRAM), and the various types of non-volatile memory (PROM, EPROM, and flash). In certain examples, the memory may be located on and/or co-located on the same computer chip as the processor.

The telematics system 104 may be in communication with a variety of sensors and other data-collecting devices of the vehicle 102. For example, the telematics system 104 may obtain, from one or more sensors, recent yaw vector data, recent speed vector data, recent acceleration vector data, GPS data, mobility patterns based on geolocation, mobility patterns based on the type of setting the vehicle 102 is in (e.g., on a highway, suburban setting, urban setting, rural setting, etc.). In some implementations, the telematics system 104 may obtain data (including mobility patterns) from a plurality of other vehicles to determine one or more profile trends for certain situations.

The telematics system 104 may be in communication with a Wi-Fi Station (STA) 106. The STA 106 may be any suitable device that can access Wi-Fi connections and allows transmission and reception of data. In some implementations, the STA 106 may be an external device such as a smartphone, tablet (e.g., an iPad^{(R)}), laptop computer, etc. In other implementations, the STA 106 may be a component of the vehicle 102, such as a computer system. The telematics system 104 may be in communication with the STA 106 via a first connection 108, which may be a wired or wireless communication. The vehicle 102 may include an antenna 110 in communication with the telematics system 104. The antenna 110 may be configured to transmit and receive data, as described in greater detail below.

The Wi-Fi system 100 may include a first access point (AP) 114a that is in communication with the telematics system 104 via a second connection 112, which is a wireless connection. The first AP 114a is in communication with a first router 118a via a third connection 116, which may be a wired or wireless connection. The first router 118a may be co-located with the first AP 114 (a). In some implementations, the AP 114a may be connected to the Internet via a satellite link. The first router 118a is in communication with the Internet 120. The Wi-Fi system 100 may include a second AP 114b in communication with a second router 118b, which is in communication with the Internet 120.

The access points 114 may be disposed in any suitable location, such as restaurants, coffee shops, gas stations, traffic lights, Electric Vehicle (EV) charging stations, etc. In certain implementations, the access points 114 are accessible by the public and available to new connections. The access points 114 may offer free or metered internet access to stations connecting to them.

Referring to FIG. 2, a method 200 for establishing a connection between the AP 114 and the STA 106 is provided. At step 202, the AP transmits a beacon to the STA 106. At step 204, the STA 106 transmits a probe to the AP 114. At step 206, the AP 114 transmits a probe response including parameters such as supported channels and rates to the STA 106. The beacon may include parameters similar to those included in the probe response 206. The STA 106 may receive these parameters either by listening to the beacon (passively) or by sending a probe and receiving a probe response (actively). At step 208, the telematics system 104 conducts a Physical (PHY) parameters selection algorithm as set forth below in FIGS. 3 and 4. At step 210, the STA 106 transmits an association request to the AP 114 and also includes the parameters as determined by the Physical (PHY) parameters selection algorithm. The PHY parameters selection algorithm proposes a set of PHY parameters such as Modulation-Coding Scheme (MCS) algorithm, Bandwidth, number of spatial streams, beamforming parameters, Resource Unit (RU) allocation, etc. for downlink data flow from AP to STA. Note that steps 208 and 210 may be in response to receiving beacon 202, or after receiving the probe response 206. At step 212, the AP 114 establishes a link with the STA 106 based on the determined parameters.

Referring to FIG. 3, a method 300 for conducting a PHY parameters selection algorithm is generally shown. The method 300 may be conducted by the telematics system 104 in conjunction with the various components controlled by and in communication with the telematics system 104. At step 302, the method 300 starts. At step 304, the telematics system 104 determines whether the STA 106 is associating with a new AP 114. If, at step 304, the telematics system 104 determines that the STA 106 is not associating with a new AP 114, then the method returns to the start 302. If, at step 304, the telematics system 104 determines that the STA 106 is associating with a new AP 114, then the method 300 proceeds to step 306, where the telematics system 104 determines whether the link between the STA 106 and the AP 114 is stable.

If, at step 306, the telematics system 104 determines that the link between the STA 106 and the AP 114 is stable (e.g., capable of providing a sufficient QoE), then the method 300 proceeds to step 308, where the telematics system 104 chooses PHY parameters corresponding to the highest data rate. At step 310, the telematics system 104 continues rate adaptation according to normal Wi-Fi operation. At step 312, the telematics system 104 determines whether dissociating is occurring. If, at step 312, the telematics system 104 determines that dissociating is not occurring, then the method 300 returns to step 310. If, at step 312, the telematics system 104 determines that dissociating is occurring, then the method 300 terminates at step 314.

If, at step 306, the telematics system 104 determines that the link between the STA 106 and the AP 114 is not stable, then the telematics system 104 consults recent yaw rate vector data at step 316, consults recent speed vector data at step 318, consults recent acceleration vector data at step 320, consults mobility pattern data in the same geolocation in step 322, consults mobility pattern data in a similar setting at step 324, and determines Quality of Service (QOS) requirements for active applications at step 326.

At step 328, the telematics system 104 chooses optimal PHY parameters based on at least one of the recent yaw vector data, the recent speed vector data, the recent acceleration vector data, the GPS data, the mobility patterns based on geolocation, the mobility patterns based on the setting in which the vehicle 102 is disposed (e.g., on a highway, suburban setting, urban setting, rural setting, etc.).

At step 330, the telematics system 104 monitors the Packet Error Rate (PER) experienced by the STA 106 based on the chosen PHY parameters. At step 342, the telematics system 104 determines whether the PER is equal to a pre-determined threshold (e.g., 5-10%) for a pre-determined amount of time (e.g., 5 seconds). If, at step 342, the telematics system 104 determines that the PER is equal to the pre-determined threshold for the pre-determined amount of time, then the telematics system 104 makes no changes and continues to monitor the PER at step 330. If, at step 342, the telematics system 104 determines that the PER is not equal to the pre-determined threshold for the pre-determined amount of time, then the telematics system 104 proceeds to step 332.

At step 332, the telematics system 104 determines whether the PER is less than a pre-determined threshold (e.g., less than 5-10%) for a pre-determined amount of time (e.g., 5 seconds). If, at step 332, the telematics system 104 determines that the PER is less than the pre-determined threshold for the pre-determined amount of time, then the telematics system 104, at step 334, changes to a PHY parameter corresponding to a higher rate and returns to step 330.

If, at step 332, the telematics system 104 determines that the PER is not less than the pre-determined threshold for the pre-determined amount of time, then the telematics system 104, at step 336, determines whether the current PHY parameter is the lowest rate. If, at step 336, the telematics system 104 determines that the current PHY parameter is the lowest rate, then the telematics system 104, at step 338, disconnects the connection between the STA 106 and the AP 114 and the method 300 terminates at step 314. If, at step 336, the telematics system 104 determines that the current PHY parameter is not the lowest rate, then the telematics system 104, at step 340, changes to a PHY parameter corresponding to a lower rate and returns to step 330.

Referring to FIG. 4, a method for conducting a PHY parameter selection algorithm is generally shown. The method 400 may be conducted by the telematics system 104 in conjunction with the various components controlled by and in communication with the telematics system 104. At step 402, the method 400 starts. At step 404, the telematics system 104 monitors the stability of the link between the STA 106 and the AP 114.

At step 406, the telematics system 104 determines whether the link between the STA 106 and the AP 114 is unstable. If, at step 406, the telematics system 104 determines that the link between the STA 106 and the AP 114 is stable, then the method 400 returns to step 404. If, at step 406, the telematics system 104 determines that the link between the STA 106 and the AP 114 is unstable, then the telematics system 104 consults recent yaw rate vector data at step 408, consults recent speed vector data at step 410, consults recent acceleration vector data at step 412, consults mobility pattern data in the same geolocation in step 414, consults mobility pattern data in similar setting at step 416, and determines Quality of Service (QOS) requirements for active applications at step 418.

At step 420, the telematics system 104 preemptively selects a new PHY parameter with a lower data rate. At step 422, the telematics system 104 monitors the Packet Error Rate (PER) experienced by the STA 106 based on the chosen PHY parameter. At step 436, the telematics system 104 determines whether the PER is equal to a pre-determined threshold (e.g., 5-10%) for a pre-determined amount of time (e.g., 5 seconds). If, at step 436, the telematics system 104 determines that the PER is equal to the pre-determined threshold for the pre-determined amount of time, then the telematics system 104 makes no changes and continues to monitor the PER at step 422. If, at step 436, the telematics system 104 determines that the PER is not equal to the pre-determined threshold for the pre-determined amount of time, then the telematics system 104 proceeds to step 424.

At step 424, the telematics system 104 determines whether the PER is less than a pre-determined threshold (e.g., less than 5-10%) for a pre-determined amount of time (e.g., 5 seconds). If, at step 424, the telematics system 104 determines that the PER is less than the pre-determined threshold for the pre-determined amount of time, then the telematics system 104, at step 426, changes to a PHY parameter corresponding to a higher rate and returns to step 422.

If, at step 424, the telematics system 104 determines that the PER is not less than the pre-determined threshold for the pre-determined amount of time, then the telematics system 104, at step 428, determines whether the current PHY parameter is the lowest rate. If, at step 428, the telematics system 104 determines that the current PHY parameter is the lowest rate, then the telematics system 104, at step 430, disconnects the connection between the STA 106 and the AP 114 and the method 300 terminates at step 432. If, at step 428, the telematics system 104 determines that the current PHY parameter is not the lowest rate, then the telematics system 104, at step 434, changes to a PHY parameter corresponding to a lower rate and returns to step 422.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A system for a vehicle comprising:
a WiFi station;
data processing hardware; and
memory hardware in communication with the data processing hardware, the memory hardware storing instructions that when executed on the data processing hardware cause the data processing hardware to perform operations comprising:
detecting an access point;
establishing a link between the access point and the WiFi station;
obtaining recent yaw rate data of the vehicle;
obtaining recent speed data of the vehicle;
obtaining recent acceleration data of the vehicle;
obtaining recent mobility pattern data of the vehicle based on geolocation data and map data; and
determining optimal physical (PHY) parameters corresponding to highest data rate based on at least one of the recent yaw rate data, the recent speed data, the recent acceleration data, or the recent mobility pattern data.

2. The system of claim 1, wherein the operations further comprise obtaining packet error rate data.

3. The system of claim 2, wherein determining the optimal PHY parameters is based at least partially on the packet error rate data.

4. The system of claim 3, wherein determining the optimal PHY parameters includes changing to different PHY parameters if the packet error rate data is below a pre-determined threshold for a pre-determined amount of time.

5. The system of claim 1, wherein the operations further comprise optimizing quality of service criteria for active applications of the system based on the determined optimal PHY parameters.

6. The system of claim 1, wherein the recent mobility pattern data includes data obtained from at least a second vehicle separate from the vehicle.

7. The system of claim 1, wherein the recent mobility pattern data includes data obtained from at least a second vehicle separate from the vehicle.

8. A computer-implemented method when executed on data processing hardware causes the data processing hardware to perform operations comprising:
detecting an access point;
establishing a link between the access point and a WiFi station;
obtaining recent yaw rate data of a vehicle;
obtaining recent speed data of the vehicle;
obtaining recent acceleration data of the vehicle;
obtaining recent mobility pattern data of the vehicle based on geolocation data and map data; and
determining optimal physical (PHY) parameters corresponding to highest data rate based on at least one of the recent yaw rate data, the recent speed data, the recent acceleration data, or the recent mobility pattern data.

9. The method of claim 8, wherein the operations further comprise obtaining packet error rate data.

10. The method of claim 9, wherein the operations further comprise obtaining packet error rate data.

11. The method of claim 10, wherein determining the optimal PHY parameters includes changing to different PHY parameters if the packet error rate data is below a pre-determined threshold.

12. The method of claim 8, wherein the operations further comprise optimizing quality of service criteria for active applications based on the determined optimal PHY parameters.

13. The method of claim 8, wherein the recent mobility pattern data includes data obtained from at least two separate vehicles.

14. The system of claim 8, wherein determining the optimal PHY parameters includes use of artificial intelligence or machine learning.

15. A computer-implemented method when executed on data processing hardware causes the data processing hardware to perform operations comprising:
detecting an access point;
establishing a link between the access point and a WiFi station;
obtaining optimization data based on recent mobility data of a vehicle;
determining optimal physical (PHY) parameters corresponding to highest data rate based on the recent mobility data of the vehicle.

16. The method of claim 15, wherein the recent mobility data includes at least one of recent yaw rate data of the vehicle, recent speed data of the vehicle, recent acceleration data of the vehicle, or recent mobility pattern data of the vehicle based on geolocation data and map data.

17. The method of claim 15, wherein the operations further comprise obtaining packet error rate data.

18. The method of claim 17 wherein determining the optimal PHY parameters is based at least partially on the packet error rate data.

19. The method of claim 18, wherein determining the optimal PHY parameters includes changing to different PHY parameters if the packet error rate data is below a pre-determined threshold.

20. The method of claim 15, wherein the operations further comprise optimizing quality of service criteria for active applications based on the determined optimal PHY parameters.
